(19) United States
(12) Patent Application Publication
(10) Pub. No.: US 2019/0047133 A1
(43) Pub. Date: Feb. 14, 2019

(54) APPLICATION-OPTIMIZED DEACTIVATION BEHAVIOR OF AN ELECTRONIC SLIPPING CLUTCH

(71) Applicant: Hilti Aktiengesellschaft, Schaan (LI)

(72) Inventors: Benedikt BECKERT, Augsburg (DE); Germar MEIENDRES, Landsberg (DE); Wolfgang SCHUBERT, Landsberg (DE)

(21) Appl. No.: 16/078,719

(22) PCT Filed: Mar. 13, 2017
(86) PCT No.: PCT/EP2017/055789

§ 371 Date: Aug. 22, 2018

(30) Foreign Application Priority Data
Apr. 6, 2016 (EP) 16164008.1

(51) Int. Cl. B25F 5/00; F16D 43/20; F16D 7/00; F16D 43/04; B25B 23/147

(52) U.S. Cl. CPC B25F 5/001; F16D 43/20; F16D 7/00; F16D 2500/50858; B25B 23/1475; F16D 2500/10481; F16D 43/04

(57) ABSTRACT

A method for operating a clutch in a power tool having an electric motor having an open-loop and closed-loop control device for closed-loop and open-loop control of motor power of the tool, and having a sensor, wherein the tool is operable in a first or second operating mode; in the first mode, the clutch is actuated after a predetermined time if a predetermined rotational speed threshold is undershot, and in the second mode, the clutch is actuated if a first predetermined motor current threshold value is exceeded. The method comprises setting the second mode; measuring the current of the motor; and reducing the motor rotational speed from a first rotational speed value to a second rotational speed value if a second predetermined current threshold value is exceeded, wherein a torque that can be generated by the tool is increased from a first torque value to a second torque value.

The present invention relates to a method for operating a clutch in a power tool, in particular of an electric screwdriver or screwdriver drill, comprising an electric motor, an open-loop and closed-loop control device for the closed-loop and open-loop control of the motor power of the power tool, and at least one sensor, wherein the power tool is operable in a first or second operating mode and, in the first operating mode, the actuation of the clutch takes place after a predetermined duration if the speed falls below a predetermined speed threshold value and, in the second operating mode, the actuation of the clutch takes place if a first predetermined motor current threshold value is exceeded.

In addition, the present invention relates to a power tool operable using the present method.

Electric screwdrivers or screwdriver drills are substantially used for screwing screws into different materials. These materials can be, for example, wood, plastics, metal, mineral materials, or the like.

When a screw is to be screwed into a material with the aid of the electric drill or screwdriver drill, with increasing penetration of the screw into the material, a correspondingly rising application of force or a corresponding torque increase is necessary to enable a nearly uniform driving speed of the screw. In particular, the so-called countersinking of the screw head, i.e., achieving a flush terminus of the planar surface of the screw head, requires a high power output, i.e., a high application of force and a high torque of the power tool. The reason for this is the special shape of the screw head, which generally has the form of a truncated cone and thus forms a correspondingly high resistance in the material.

One problem can arise in this context if multiple screws having identical lengths are to be screwed flush (i.e., countersunk screw heads) into a material which does not have uniform hardness. Wood in particular often does not have a continuously homogeneous structure, and therefore the degree of hardness of the wood can differ greatly. During the screwing in of a first screw at a first point of the wood, it is possible that a relatively small application of force or a relatively low torque is required. However, a substantially greater application of force or a higher torque can be necessary at another point of the same wood for screwing in a second (identical) screw to equal depth. This problem becomes particularly clear when screwing in and/or countersinking the screw head in the form of a truncated cone.

In addition, this is made more difficult because the electric screwdriver or screwdriver drill, which is typically operated using a rechargeable battery, and has to be made small and compact in order to be practical for the user. However, the performance of the power tools is also decreased at the same time.

In addition, excessively early triggering of the clutch can represent a problem. In the event of an excessively high application of force or torque for the countersinking of a screw head, the clutch triggers (i.e., disconnects the drivetrain) early as a result of the special setting, and therefore sufficient torque can no longer be provided at the screw and therefore it is no longer possible to drive the screw. The user is forced in such a situation to release the switch of the power tool and actuate it again. In this way, the clutch is deactivated and the drivetrain is closed, and therefore the required torque can again be generated, in order to drive the screw further. Such an interruption of the work procedure means an undesired lengthening of the work procedure, however.

The object of the present invention is therefore to solve the above-mentioned problem and in particular to ensure proper screwing of screws into a heterogeneous material using a nearly uniform application of force or torque.

The object is achieved by the subject matter of independent claim 1 and accordingly by the subject matter of independent claim 4. The dependent claims contain advantageous embodiments.

The object is achieved in particular in this case by a method for operating a clutch in a power tool, in particular an electric screwdriver or screwdriver drill, comprising an electric motor, an open-loop and closed-loop control device for the closed-loop and open-loop control of the motor power of the power tool, and at least one sensor, wherein the power tool is operable in a first or second operating mode and, in the first operating mode, the actuation of the clutch takes place after a predetermined duration if the speed falls below a predetermined speed threshold value and, in the second operating mode, the actuation of the clutch takes place if a first predetermined motor current threshold value is exceeded.

According to the invention, the method contains the following method steps:
setting the second operating mode;
measuring the motor current of the electric motor; and
reducing the motor speed from a first speed value to a second speed value if a second predetermined motor current threshold value is exceeded, whereby a torque which can be generated by the power tool is elevated from a first torque value to a second torque value.

Due to the reduction of the speed as a function of the motor torque, continuous working at a correspondingly high torque can be ensured. The reduced speed is additionally used in this case for a reduced and thus reliable driving velocity, and therefore unintentional excessively deep penetration of the screw head into the material can be counteracted. It is to be noted that the power tool is not switched off for this purpose and the flush terminating countersinking of the screw head at the surface of the material takes place with visual monitoring by the user. The relatively slow rotational velocity enables in this case the most accurate possible countersinking or placement of the screw head. The second torque value can be the maximum torque which can be generated by the power tool.

The first operating mode of the power tool is provided for a so-called hard screw case (also hard joint) and the second operating mode is provided for a so-called soft screw case (soft joint). In the event of a hard screw case, screws are screwed into a relatively hard material (for example, metal) and in the event of a soft screw case, screws are screwed into a relatively hard material (for example, spruce wood).

In this case, the first predetermined motor current threshold value is higher than the second predetermined motor current threshold value.

According to one advantageous embodiment of the present invention,

detection of a first and second position value and a first and second alignment value for the power tool by means of at least one sensor; and

reduction of the motor speed from a first speed value to a second speed value if a difference between the first and second position value or a difference between the first and second alignment value falls below a predetermined threshold value can be provided. It can be established in this way whether the position and/or alignment of the power tool changes during the procedure of screwing. This is because if a change of the position and/or alignment of the power tool can accordingly be determined on the basis of the size of the difference value, it can be presumed that the power tool is moved from a first screw to a second screw and the second screw is now being screwed instead of the first screw. In this case, the speed is not reduced accordingly and can be selected by the user according to the position of the activation switch of the power tool. In the case of a correspondingly small difference value, however, it can be presumed that the position and/or alignment of the power tool does not change during the procedure screwing and the same screw is still being screwed. In this case, the speed is reduced and the torque is elevated accordingly. Therefore, in a continuous screwing procedure at one screw, on the one hand, an elevated torque, and, on the other hand, a slow rotational velocity for accurate countersinking of the screw head can be provided to the user by the reduced speed.

According to a further advantageous embodiment of the present invention,

setting of an operating switch of the power tool into an activation mode;

setting of the operating switch into a deactivation mode;

setting of an operating switch into the activation mode;

detection of a first and second position value and a first and second alignment value for the power tool by means of the at least one sensor; and

reduction of the motor speed from a first speed value to a second speed value if a difference between the first and second position value or a difference between the first and second alignment value falls below a predetermined threshold value, wherein the second speed value corresponds to pulsed operation of the electric motor, can be provided.

In this way it can be established whether the position and/or alignment of the power tool changes during the procedure of screwing. This is because if a change of the position and/or alignment of the power tool can accordingly be determined on the basis of the size of the difference value, it can be presumed that the power tool is moved from a first screw to a second screw and the second screw is now being screwed instead of the first screw. In this case, the speed is not reduced accordingly and can be selected by the user according to the position of the activation switch of the power tool. In the case of a correspondingly small difference value, however, it can be presumed that the position and/or alignment of the power tool does not change during the procedure of screwing and the same screw is still being screwed. In this case, the speed is reduced to pulsed operation and the torque is elevated accordingly. Therefore, in a continuous screwing procedure at one screw, an elevated torque is provided to the user by the pulsed operation of the electric motor, on the one hand, and a slow rotational velocity for accurate countersinking of the screw head is provided, on the other hand. The countersinking of the screw head can be estimated or monitored even more accurately by the user using the pulsed operation, which causes a temporary or repeating partial rotation of the screw.

The sensor can be designed in this case as a gyroscopic sensor, linear sensor, or the like.

The object is moreover achieved by a power tool operable using the method according to the invention.

According to one advantageous embodiment of the present invention, it can be provided for the power tool that a transmission unit comprising at least one first and one second gear is provided, wherein in the one gear, the torque which can be generated by the power tool is in a logarithmic ratio to a motor current increase and in another gear, the torque which can be generated by the power tool is in a linear ratio to a motor current increase. In this way, a higher torque can be generated in one gear in comparison to the other gear at equal speed, whereby flush countersinking of a screw head is facilitated.

Further advantages result from the following description of the figures. Various exemplary embodiments of the present invention are illustrated in the figures. The figures, the description, and the claims contain numerous features in combination. A person skilled in the art will advantageously also consider the features individually and combine them into reasonable further combinations.

Identical and equivalent components are identified by identical reference signs in the figures. In the figures:

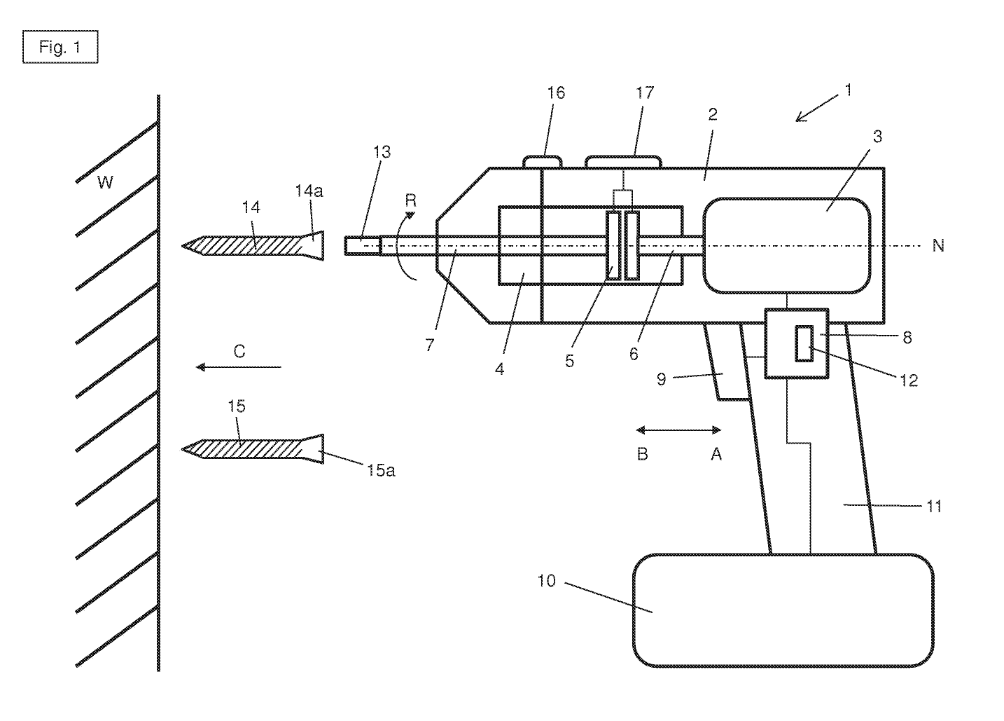

FIG. 1 shows a schematic illustration of a power tool according to the invention for carrying out the method according to the invention.

### EXEMPLARY EMBODIMENT

FIG. 1 shows a power tool 1 according to the invention for operating the method according to the invention.

The power tool 1 is embodied in the form of an electric screwdriver or screwdriver drill and substantially contains a housing 2, an electric motor 3 as the drive, a transmission 4 comprising a clutch 5, a driveshaft 6, an output shaft 7, an open-loop and closed-loop control device 8, an activation switch 9, and a rechargeable battery 10.

The electric motor 3, the transmission 4, the driveshaft 6, and the output shaft 7 are positioned in the housing 2. A first end of a handle 11 for holding the power tool 1 is arranged on the lower side of the housing 2. The activation switch 9 of the power tool 1 is located on the handle 11. The rechargeable battery 10 is detachably attached as an energy source for the power tool 1 at a second end of the handle 11.

The open-loop and closed-loop control device 8 open-loop controls and closed-loop controls, inter alia, the electric motor 3. For this purpose, the open-loop and closed-loop control device 8 is connected to the activation switch 9, the rechargeable battery 10, and also to the electric motor 3. In particular, the motor current, the speed, and the generated torque can be measured, open-loop controlled, and closed-loop controlled using the open-loop and closed-loop control device 8. The measurement takes place in this case with the aid of sensors (not shown in the figures).

Furthermore, the power tool contains sensors 12, which can measure various parameters of the power tool and transmit them to the open-loop and closed-loop control device 8. The sensors 12 are gyroscopic sensors and/or acceleration sensors and linear sensors and/or position sensors. The sensors 12 are used to determine a position change and/or alignment change of the power tool 1.

The electric motor 3 generates a torque and transmits it to the driveshaft 6. The driveshaft 6 is in turn connected to the transmission 4. The transmission 4 contains the clutch 5, which can be embodied in the form of a slipping clutch. A first gear or a second gear can be selected and set in the transmission 4. The output shaft 7 is connected to the transmission 4. The clutch 5 connects or disconnects the driveshaft 6 to or from, respectively, the output shaft 7. A bit 13 (the bit can also be referred to as a screwdriver blade) is fastened on the free end 7a of the output shaft 7. The bit 13 can be inserted into a screw head profile 14a, 15a of a screw 14, 15 (for example, flathead, Phillips, or the like).

A torque is generated with the aid of the electric motor 3. The generated torque is transmitted to the driveshaft 6, the transmission 4, the clutch 5, the output shaft 7, and finally to the bit 13. If the bit 13 is inserted into the screw head profile 14a, 15a of the screw 14, 15, the torque generated by the electric motor 3 is transmitted to the screw 14, 15 and the screw 14, 15 is rotated in a rotational direction R about a center axis N. Due to the torque acting on the screw 14, 15, the screw 14, 15 can penetrate into the material W and be fastened therein.

The activation of the clutch 5 is dependent on the measured motor current. The motor current is a function in this case of the torque generated by the electric motor 3. The torque generated by the electric motor 3 can thus be determined by the detection of the motor current. If the measured motor current exceeds a predetermined value, the clutch 5 is activated, i.e., the driveshaft 6 and the output shaft 7 are disconnected from one another. The power tool 1 is designed in this case such that in the first gear, the torque generated by the power tool 1 is in a logarithmic ratio to a motor current increase and in a second gear, the torque which can be generated by the power tool 1 is in a linear ratio to a motor current increase. In this way, a higher torque can be generated in the first gear than in the second gear at identical motor current, without the clutch 5 disconnecting the driveshaft 6 and the output shaft 7.

If a screw 14, 15 is to be screwed into a material W, a gear for the transmission 4 is firstly selected with the aid of a selection switch 16. A first or a second gear can be selected in this case. However, it is also possible in an alternative embodiment that more than two gears are selectable.

Subsequently, the corresponding operating mode is selected. It is possible to select between the first operating mode for a soft screw case and the second operating mode for a hard screw case. In the present case, the second operating mode is selected, wherein in the second operating mode, the actuation of the clutch 5 takes place if a first predetermined motor current threshold value is exceeded.

The selection of the first or second operating mode takes place by means of a selection switch. The selection switch is not shown in the figures.

Next, the triggering condition of the clutch 5 is set with the aid of a setting device 17. It is determined by this setting from which torque, which is generated by the electric motor 3 and transmitted to the screw 14, 15, the clutch 5 is to disconnect the driveshaft 6 and the output shaft 7. As described above, the torque is determined on the basis of the motor current.

A first screw 14 is screwed with the aid of the bit 13 into the material W. The activation of the power tool 1 or the electric motor 3 takes place by actuating (pressing) the activation switch 9. The activation switch 9 is moved for this purpose in the arrow direction A. In order to switch off the power 1 or stop the electric motor 3, the activation switch 9 is moved in the arrow direction B. The movement in the arrow direction B is carried out by a spring (not shown). The corresponding sensors continuously measure the motor current in this case. If the torque derived from the motor current does not exceed a previously established threshold value, the screw 14 is screwed into the material W in the direction C up to the stop. The highest torque is generally necessary for the flush countersinking of the screw head 14a, since it generates the greatest resistance in the material W due to its truncated cone shape.

After the first screw 14 has been screwed into the material W, a second screw 15 is screwed into the material W at another point. It is possible in this case that the second screw 15 is to be screwed in at a point at which the material W is harder than at the point of the first screw 14. In this case, a higher torque is necessary for the screwing in. If the threshold value for the motor current, using which the generated torque can be determined, is exceeded during the screwing in of second screw 15 at a hard point of the material W, the clutch 5 is not activated and thus does not disconnect the driveshaft 6 and the output shaft 7. Instead, the speed of the electric motor is reduced, and therefore the torque can be increased accordingly. The second screw 15 and in particular the screw head 15a can be screwed flush even into a hard material W by the elevated torque. The user of the power tool 1 does not have to release the activation switch 9 in this case (in the arrow direction B), but rather can keep it pressed (in the arrow direction A), since the reduction of the speed and thus the elevation of the torque take place automatically. Due to the low speed and the slow penetration of the screw 14, 15 into the material W linked thereto, it is moreover easier for the user to observe when the screw 14, 15 or the screw head 14a, 15a presses flush against the surface of the material W. Excessively deep penetration of the screw 14, 15 into the material W can thus be prevented.

An alternative embodiment of the present invention will be described hereafter. In the case in which an excessively high torque is required for the screwing in and this is determinable on the basis of a motor torque lying above a threshold value, the electric motor 3 is completely stopped. The user thereupon releases the activation switch 9 (in the arrow direction B) and subsequently actuates it again (in the arrow direction A). The sensors 12, i.e., the gyroscopic sensors and/or acceleration sensors and the linear sensors and/or position sensors, do not determine a position or alignment change of the power tool 1, however. This means that the power tool 1 was not moved away from the screw 14, 15, and the same screw 14, 15 is still supposed to be screwed. In this way, it is indicated to the open-loop and closed-loop control device 8 that the electric motor 3 is supposed to rotate at a low speed and accordingly generate high torque. Alternatively, the electric motor 3 can also be operated with pulsed operation instead of at a reduced speed. In pulsed operation, the output shaft 7 only rotates in quarter rotations about the center axis N. The torque is also elevated in this way and the screwing in of the screw 14, 15 and also the flush countersinking of the screw head 14a, 15a can be continued.

However, if the sensors 12, i.e., the gyroscopic sensors and/or acceleration sensors and the linear sensors and/or position sensors, determine a position or alignment change of the power tool 1 (i.e., on the basis of exceeding of a threshold value and/or falling below a difference value of a first and second position or alignment value), it can be presumed that the power tool 1 was moved from one screw 14 to another screw 15. Therefore, screwing is no longer performed on the same screw 14. In such a case, if the user releases the activation switch 9 (in the arrow direction B) and subsequently actuates it again (in the arrow direction A), the speed of the electric motor 3 is not reduced and pulsed operation is also not set. The new screw 15 can now be screwed again using the full speed range.

1. A method for operating a clutch in a power tool comprising an electric motor; an open-loop control device and a closed-loop control device for closed-loop and open-loop control of motor power of the power tool; and at least one sensor; wherein the power tool is operable in a first operating mode ora second operating mode and, in the first operating mode, the clutch is actuated after a predetermined duration if a speed of the motor falls below a predetermined speed threshold value and, in the second operating mode, the clutch is actuated if a first predetermined motor current threshold value is exceeded,
the method including
setting the second operating mode;
measuring motor current of the electric motor; and
reducing the motor speed from a first speed value to a second speed value if a second predetermined motor current threshold value is exceeded, wherein a torque which can be generated by the power tool is elevated from a first torque value to a second torque value.

2. The method as claimed in claim 1,
the method including
acquiring a first position value and a second position value and a first alignment value and a second alignment value for the power tool by the at least one sensor; and
reducing the motor speed from a first speed value to a second speed value if a difference between the first position value and the second position value or a difference between the first alignment value and the second alignment value falls below a predetermined threshold value.

3. The method as claimed in claim 1,
the method including
setting an activation switch of the power tool into an activation mode;
setting the activation switch into a deactivation mode;
setting an activation switch into the activation mode;
acquiring a first position value and a second position value and a first alignment value and a second alignment value for the power tool by the at least one sensor; and
reducing the motor speed from a first speed value to a second speed value if a difference between the first position value and the second position value or a difference between the first alignment value and the second alignment value falls below a predetermined threshold value, wherein the second speed value corresponds to pulsed operation of the electric motor.

4. A power tool operable using the method as claimed in claim 1.

5. The power tool as claimed in claim 4, wherein a transmission comprising at least one first gear and one second gear is provided, wherein in the one first gear, the torque which can be generated by the power tool is in a logarithmic ratio to a motor current increase and, in another gear, the torque which can be generated by the power tool is in a linear ratio to a motor current increase.

6. A power tool operable using the method as claimed in claim 2.

7. A power tool operable using the method as claimed in claim 3.

8. The power tool as claimed in claim 6, wherein a transmission comprising at least one first gear and one second gear is provided, wherein in the one first gear, the torque which can be generated by the power tool is in a logarithmic ratio to a motor current increase and, in another gear, the torque which can be generated by the power tool is in a linear ratio to a motor current increase.

9. The power tool as claimed in claim 7, wherein a transmission comprising at least one first gear and one second gear is provided, wherein in the one first gear, the torque which can be generated by the power tool is in a logarithmic ratio to a motor current increase and, in another gear, the torque which can be generated by the power tool is in a linear ratio to a motor current increase.
